(19) United States
(12) Patent Application Publication
(10) Pub. No.: US 2022/0385097 A1
(43) Pub. Date: Dec. 1, 2022

(54) SYSTEM FOR CHARGING/DISCHARGING BATTERY

(71) Applicant: SK On Co., Ltd., Seoul (KR)

(72) Inventors: Seong Gi LIM, Daejeon (KR); Keun Woo KIM, Daejeon (KR); Hae Kwon RYU, Daejeon (KR); Jun Woo LEE, Daejeon (KR); Chang Hyun HWANG, Daejeon (KR)

(21) Appl. No.: 17/745,966

(22) Filed: May 17, 2022

(30) Foreign Application Priority Data
May 25, 2021 (KR) 10-2021-0066988

(51) Int. Cl. H02J 7/34; H02J 7/00; H02J 7/02

(52) U.S. Cl. CPC H02J 7/342; H02J 7/0013; H02J 7/02; H02J 7/0047; H02J 2207/20

(57) ABSTRACT

A system for charging and discharging a battery, includes: a battery charging-discharging device performing a charging process and a discharging process of a plurality of battery cells for each group; and an energy storage device, during a discharging process of battery cells of a first group, storing a discharged energy of the battery cells of the first group in a plurality of batteries, and, during a charging process of battery cells of a second group, supplying energy stored in the plurality of batteries to the battery cells of the second group.

### CROSS-REFERENCE TO RELATED APPLICATION(S)

This application claims the benefit under 35 USC 119(a) of Korean Patent Application No. 10-2021-0066988 filed on May 25, 2021 in the Korean Intellectual Property Office, the entire disclosure of which is incorporated herein by reference for all purposes.

### BACKGROUND

The present disclosure relates to a system for charging and discharging a battery.

An activation process in a battery manufacturing process refers to a process of activating a battery by repeating a charging process and a discharging process several times so that an initial battery, may store electrical energy. A capacity of a battery cell is continuously increased, and accordingly, power consumption of a battery charging-discharging device increases. Accordingly, research is being actively conducted to recover and reuse discharged energy of the battery cell during the activation process. However, since most of the discharged energy of the battery cell is converted into thermal energy and lost, an energy recovery rate is low.

### SUMMARY

An aspect of the present disclosure is to provide a battery charging-discharging system capable of increasing a recovery rate of discharged energy of a battery charging-discharging device.

According to an aspect of the present disclosure, a battery charging-discharging system, includes: a battery charging-discharging device performing a charging process and a discharging process of a plurality of battery cells for each group; and an energy storage device, during a discharging process of battery cells of a first group, storing discharged energy of the battery cells of the first group in a plurality of batteries, and, during a charging process of battery cells of a second group, supplying energy stored in the plurality of batteries to the battery cells of the second group.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a comparative example of a battery charging-discharging device according to an embodiment of the present disclosure.

FIG. 2 is a diagram illustrating a battery charging-discharging system according to an embodiment of the present disclosure.

FIG. 3 is a flowchart illustrating a method of charging and discharging battery cells of a first group according to an embodiment of the present disclosure.

FIGS. 4 and 5 are data flow charts for illustrating a method of charging and discharging battery cells of a first group according to an embodiment of the present disclosure.

FIG. 6 is a flowchart illustrating a method of charging and discharging cells of a second group according to an embodiment of the present disclosure.

FIG. 7 is a data flow diagram illustrating a method of charging a second group of cells according to an embodiment of the present disclosure.

### DETAILED DESCRIPTION

The details of other embodiments are included in the detailed description and drawings.

Advantages and features of the present disclosure and methods of achieving the same will become apparent with reference to the embodiments described below in detail in conjunction with the accompanying drawings. However, the present disclosure is not limited to the embodiments disclosed below, and may be implemented in various different forms, and only the present embodiments allow the present disclosure to be complete, and are provided to completely inform those skilled in the art to which the present disclosure pertains to, and the present disclosure is only defined by the scope of the claims. Like reference numerals refer to like elements throughout the specification.

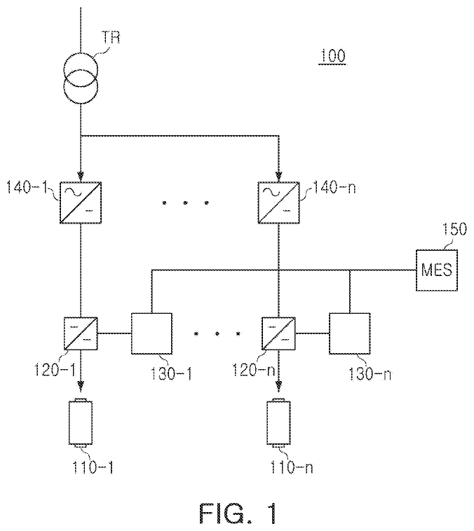

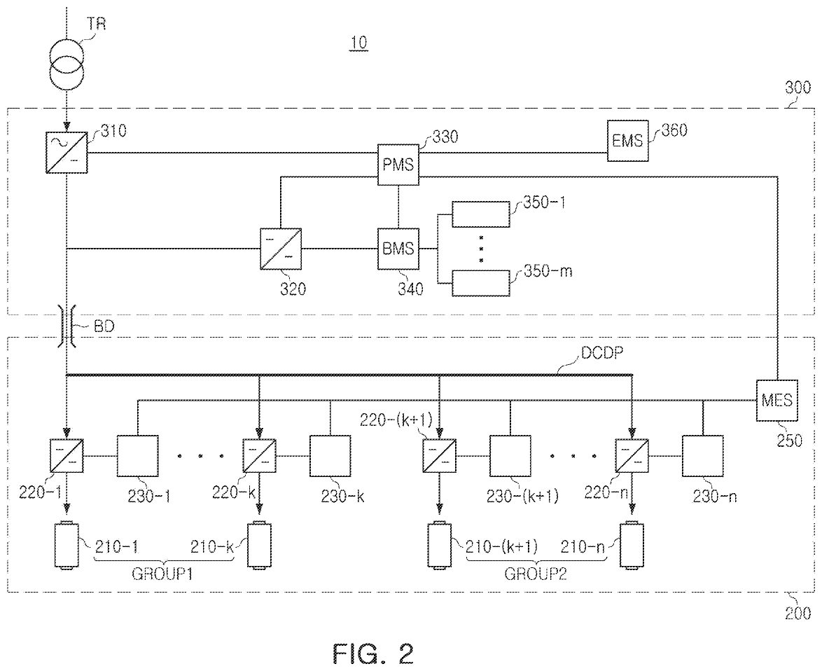

FIG. 1 is a comparative example of a battery charging-discharging device according to an embodiment of the present disclosure, and FIG. 2 is a diagram illustrating a battery charging-discharging system according to an embodiment of the present disclosure.

First, referring to FIG. 1, a battery charging-discharging device 100 may include a plurality of DC-DC converters 120-1 to 120-n, respectively connected to a plurality of battery cells 110-1 to 110-n, a plurality of charging-discharging controllers 130-1 to 130-n respectively connected to the plurality of DC-DC converters 120-1 to 120-n, a plurality of power conversion devices respectively connected to the plurality of DC-DC converters 120-1 to 120-n (power conversion systems/power conditioning systems (PCS)) (140-1 to 140-n), and a manufacturing execution system (MES); 150.

The battery charging-discharging device 100 may activate a battery by repeatedly performing the charging process and discharging process several times so that the first battery, assembled during the battery production process, can store electrical energy. That is, the battery charging-discharging device 100 may activate the plurality of battery cells 110-1 to 110-n by performing a charging process and a discharging process of the plurality of battery cells 110-1 to 110-n.

Each of the plurality of PCSs 140-1 to 140-n may serve to convert alternating current (AC) power of a power grid into direct current (DC) power and store the same in a battery, invert the DC power stored in the battery into AC power to discharge the same to a power grid. For example, each of the plurality of PCSs 140-1 to 140-n may convert AC power (e.g., 220V) delivered through a transformer TR to DC power (e.g., 380V), and output the converted DC power to the DC-DC converters 120-1 to 120-n corresponding to the PCSs.

The MES 150 may transmit a charge initiation command or a discharge initiation command to the plurality of charging-discharging controllers 130-1 to 130-n. The charging initiation command may be a command to start a charging process for the plurality of battery cells 110-1 to 110-n, and the discharging initiation command may be a command to start a discharging process for the plurality of battery cells 110-1 to 110-n. The plurality of charging-discharging controllers 130-1 to 130-n may receive a charge initiation command or a discharge initiation command from the MES 150, and control the plurality of DC-DC converters 120-1 to 120-n in response to the charge initiation command or the discharge initiation command.

For example, when the plurality of charging-discharging controllers 130-1 to 130-n receive a charge initiation command from the MES 150, the plurality of DC-DC converters 120-1 to 120-n may convert a high voltage (e.g., 380V DC voltage) output from the plurality of PCSs 140-1 to 140-n into a low voltage (e.g., 14V DC voltage), and supply the converted low voltage into the plurality of battery cells 110-1 to 110-n.

For example, when the plurality of charging-discharging controllers 130-1 to 130-n receives a discharge initiation command from the MES 150, the plurality of DC-DC converters 120-1 to 120-n may discharge the plurality of battery cells 110-1 to 110-n.

The battery charging-discharging device 100 may further include circuits for recovering and reusing discharged energy of the plurality of battery cells 110-1 to 110-n. However, in the battery charging-discharging device 100, since the plurality of PCSs 140-1 to 140-n are respectively connected for each of the plurality of DC-DC converters 220-1 to 220-n, while the charging-discharging process is performed, energy may be converted into thermal energy and lost in the AC-DC conversion process.

In addition, since the battery charging/discharging device 100 repeat charging and discharging for each battery cell, there is a large difference between the number of battery cells being charged and the number of battery cells being discharged. Due thereto, most of the discharged energy may be converted into thermal energy and lost.

Accordingly, even if the battery charging-discharging device 100 recovers and reuses the discharged energy of the plurality of battery cells 110-1 to 110-n, a recovery rate of the energy may decrease.

According to an embodiment of the present disclosure, a power supply grid of the battery charging-discharging device may be unified as DC power, and charging-discharging may be performed for each group of a plurality of battery cells. Discharged energy of battery cells of a first group may be stored in an energy storage device connected to the battery charging-discharging device, and energy stored in the energy storage device may be reused when charging battery cells of a second group. Accordingly, a recovery rate of the discharged energy of the battery charging-discharging device may be increased.

In addition, discharged energy of the plurality of battery cells in the energy storage device during late night, and energy stored in the energy storage device, may be supplied to the plurality of battery cells during the day, when a unit price of power is the highest and an usage is the highest, thereby reducing costs.

Referring to FIG. 2, the battery charging-discharging system 10 may include a battery charging-discharging device 200 and an energy storage device 300.

The battery charging-discharging device 200 may include a plurality of DC-DC converters 220-1 to 220-n respectively connected to a plurality of battery cells 210-1 to 210-n, a plurality of charging-discharging controllers 230-1 to 230-n respectively connected to the plurality of DC-DC converters 220-1 to 220-n, and an MES 250 connected to the plurality of charging-discharging controllers 230-1 to 230-n. The battery charging-discharging device 200 may group the plurality of battery cells 210-1 to 210-n, and perform a charging process and a discharging process of the plurality of battery cells 210-1 to 210-n for each group.

The energy storage device 300 may include a first PCS 310, a second PCS 320, a power management system (PMS) 330, a battery management system (BMS) 340, a plurality of batteries 350-1 to 350-m, and an energy management system (EMS) 360. The energy storage device 300 may store discharged energy of battery cells of a first group (GROUP 1) during a discharging process of the battery cells of the first group (210-1 to 210-k; GROUP1) in a plurality of batteries 350-1 to 350-m, and supply energy stored in the plurality of batteries 350-1 to 350-m during a charging process for battery cells of a second group of (210-(k+1) to 210-n; GROUP2) to the battery cells of the second group (GROUP 2). Where m, k, and n are natural numbers, and n is greater than k.

Unlike the battery charging-discharging device 100 of FIG. 1, the battery charging-discharging device 200 of FIG. 2 may further include a DC power distribution board (DCDP) in which a plurality of DC-DC converters 220-1 to 220-n are connected in parallel. The large-capacity first PCS 310 may convert AC power (e.g., 380V) delivered through a transformer (TR) to DC power (e.g., 580V), and supply the converted DC power to the battery charging-discharging device 200. The DC distribution board (DCDP) may receive the DC power supplied from the first PCS 310 through a bus duct BD, and distribute the same to the plurality of battery cells 210-1 to 210-n through the plurality of DC-DC converters 220-1 to 220-n.

The EMS 360 may be a server for monitoring whether abnormalities are present in an entire energy and a power grid. The PMS 330 may control power in conjunction with the EMS 360. For example, the PMS 330 may transmit data on items (e.g., power quality) monitored by the PMS 330 to the EMS 360, and the EMS 360 may store and display the data. In the present specification, the first PCS 310 and/or the second PCS 320 may transmit a status of whether or not it is operating normally to the PMS 330. The PMS 330 may monitor a status of whether or not the first PCS 310 and/or the second PCS 320 are operating normally, and transmit status information to the EMS 360.

The second PCS 320 may store the discharged energy of the plurality of battery cells 210-1 to 210-n in the plurality of batteries 350-1 to 350-m, or supply energy stored in the plurality of battery cells 350-1 to 350-m to the plurality of battery cells 210-1 to 210-n.

The BMS 340 may monitor statuses of voltage, current, temperature, and the like, of the plurality of batteries 350-1 to 350-m, and control charging and discharging of the plurality of batteries 350-1 to 350-m according to the monitoring result. In addition, the BMS 340 may perform cell balancing of the plurality of batteries 350-1 to 350-m, and determine remaining capacities of the plurality of batteries 350-1 to 350-m. In addition, when a danger is sensed, the BMS 340 may protect the plurality of batteries 350-1 to 350-m through an emergency operation.

The BMS 340 may generate status information according to a result of monitoring the status of the plurality of batteries 350-1 to 350-m, and output the status information. The PMS 330 may receive the status information from the BMS 340, and control an operation of the second PCS 320 based on the status information. For example, the state information may include whether the status of the plurality of batteries 350-1 to 350-m are chargeable or dischargeable.

The plurality of batteries 350-1 to 350-m may be lithium-ion batteries capable of storing large-capacity power, but an embodiment thereof is not limited thereto.

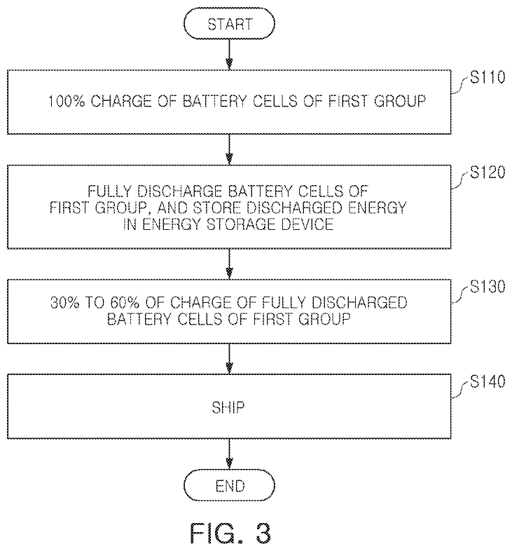

Hereinafter, an activation process for a plurality of battery cells will be described with reference to FIGS. 3 to 7.

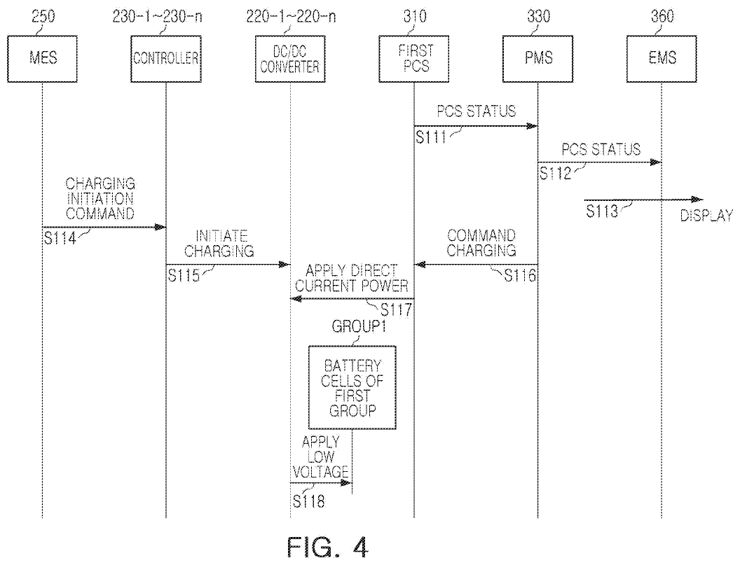

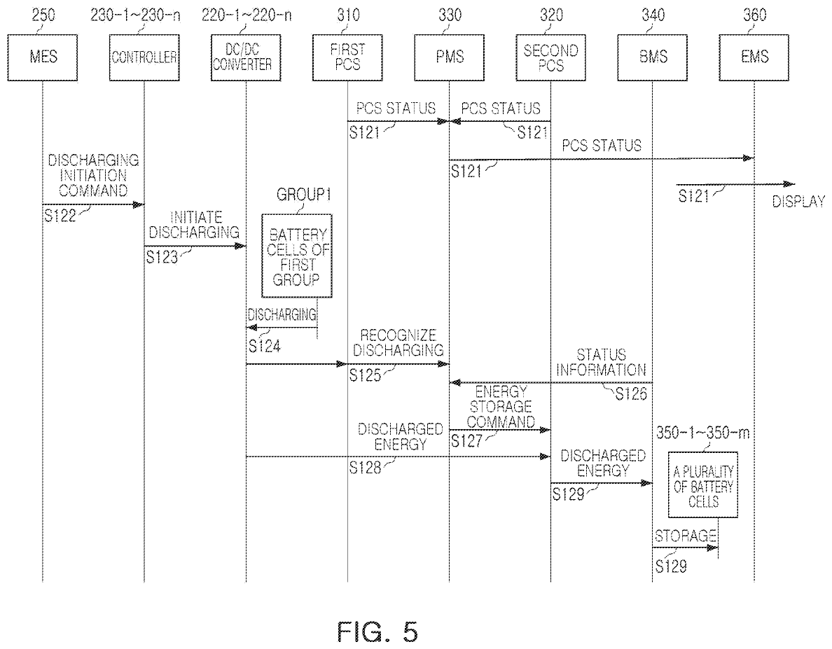

FIG. 3 is a flowchart illustrating a method for charging and discharging a first group of battery cells according to an embodiment of the present invention, and FIGS. 4 and 5 are data flow charts for illustrating a method of charging and discharging battery cells of a first group according to an embodiment of the present disclosure.

First, referring to FIG. 3, the battery charging-discharging device may charge 100% of battery cells of a first group GROUP1 (S110).

When an operation of operation S110 is described in detail with reference to FIG. 4, a PMS 330 may monitor a status of whether or not a first PCS 310 is operating normally (S111), and transmit the monitoring result to an EMS 360 (S112). The EMS 360 may display a status of whether or not the first PCS 310 is operating normally (S113).

The MES 250 may transmit a charging initiation command for notifying a start of a charging process for the battery cells of the first group GROUP1 to a plurality of charging-discharging controllers 230-1 to 230-n (S114).

The plurality of charging-discharging controllers 230-1 to 230-n may control a plurality of DC-DC converters 220-1 to 220-n to initiate charging of the plurality of battery cells GROUP1 (S115) in response to the charging initiation command.

The PMS 330 may transmit a charging command to a first PCS 310 in response to the charging initiation command (S116). The first PCS 310 may convert AC power (e.g., 380V) transmitted through a transformer TR into DC power (e.g., 580V) in response to the charging command.

The plurality of DC-DC converters 220-1 to 220-n may receive a high voltage (e.g., 580V DC voltage) output from the first PCS 310 (S117). The plurality of DC-DC converters 120-1 to 120-n may convert a high voltage (e.g., 580V DC voltage) to a low voltage (e.g., 5V DC voltage), and supply the converted low voltage to the battery cells of the first group (GROUP1) (S118).

Referring back to FIG. 3, after the battery charging-discharging device charges 100% of the battery cells GROUP1 of the first group GROUP1, the battery charging-discharging device may perform full discharging (S120). When the battery charging-discharging device discharges the battery cells of the first group GROUP1, discharged energy may be stored in the energy storage device (S120).

An operation of S120 will be specifically described with reference to FIG. 5, a PMS 330 may monitor a status of whether or not a first PCS 310 and/or a second PCS 320 are operating normally, and may transmit the monitoring result to an EMS 360 (S121). The EMS 360 may display the status of whether or not the first PCS 310 and/or the second PCS 320 are operating normally (S121).

The MES 250 may transmit a discharging initiation command for notifying a start of a discharge process for battery cells of a first group GROUP1 to a plurality of charging-discharging controllers 230-1 to 230-n (S122).

The plurality of charging-discharging controllers 230-1 to 230-n may control the plurality of DC-DC converters 220-1 to 220-n to initiate discharging the battery cells of the first group (GROUP1) in response to the discharging initiation command (S123).

The plurality of DC-DC converters 220-1 to 220-n may convert a low voltage (e.g., 5V DC voltage) discharged from the battery cells of the first group GROUP1 into a high voltage (e.g., 580V DC voltage) (S124), and output the converted high voltage.

During the discharging process, the PMS 330 may recognize the discharging of the battery cells of the first group GROUP1 through the first PCS 310 (S125).

The BMS 340 may transmit status information indicating that a status of a plurality of batteries 350-1 to 350-m are chargeable to a PMS 330 (S126). The PMS 330 may transmit an energy storage command to a second PCS 320 in response to the status information (S127). The second PCS 320 may store discharged energy of the battery cells of the first group GROUP1 in the plurality of batteries 350-1 to 350-m according to the energy storage command. Specifically, when the plurality of DC-DC converters 120-1 to 120-n transmit the converted high voltage to the second PCS 320 (S128), discharged energy may be stored in the plurality of batteries 350-1 to 350-m under the control of the BMS 340 (S129).

Referring back to FIG. 3, the fully discharged battery cells of the first group may be shipped (S140), after a 30 to 60% charging process is performed (S130).

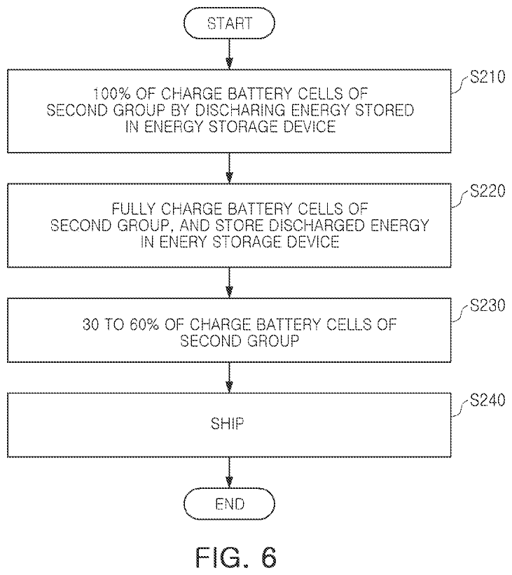

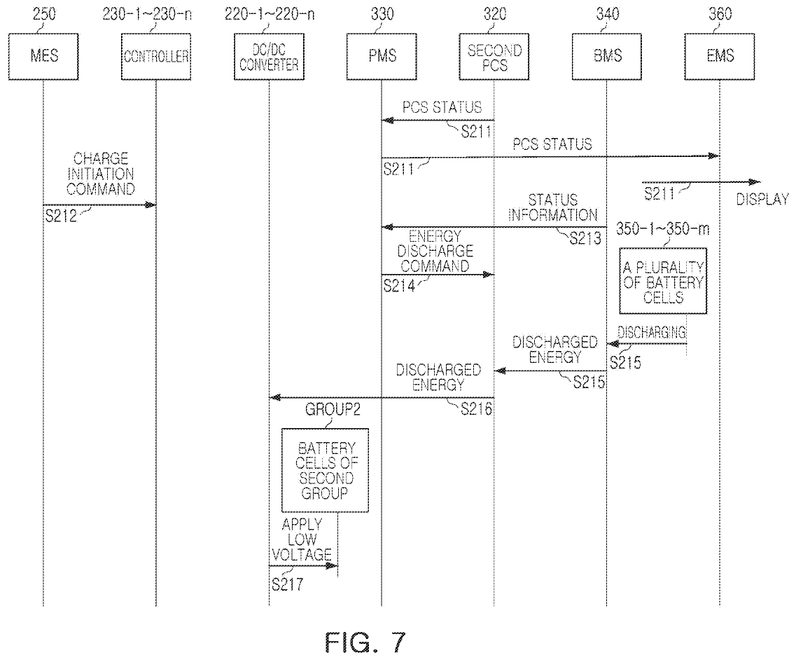

FIG. 6 is a flowchart illustrating a method for charging and discharging cells of a second group according to an embodiment of the present disclosure, and FIG. 7 is a data flow diagram illustrating a method of charging cells of a second group according to an embodiment of the present disclosure.

First, referring to FIG. 6, a battery charging-discharging device may charge 100% of battery cells of a second group GROUP2 (S210). When the battery charging-discharging device charges the battery cells of the second group, energy stored in an energy storage device may be discharged to be utilized when charging the battery cells of the second group (S210).

An operation of S210 will be described in detail with reference to FIG. 7, a PMS 330 may monitor whether a second PCS 320 is operating normally, and may transmit the monitoring result to an EMS 360 (S211). The EMS 360 may display a status of whether or not the second PCS 320 is operating normally (S211).

The MES 250 may transmit a charging initiation command for notifying a start of a charging process for the battery cells of the second group GROUP2 to a plurality of charging-discharging controllers 230-1 to 230-n (S212).

The BMS 340 may transmit status information indicating that a status of a plurality of batteries 350-1 to 350-m are dischargeable to a PMS 330 (S213). The PMS 330 may transmit an energy discharge command to a second PCS 320 in response to the status information (S214). The second PCS 320 may supply energy stored in the plurality of batteries 350-1 to 350-m to the battery cells of the second group GROUP2 according to an energy discharge command. Specifically, discharged energy may be discharged from the plurality of batteries 350-1 to 350-m under the control of the BMS 340 (S215), and the discharged energy discharged from the plurality of batteries 350-1 to 350-m may be supplied to the plurality of DC-DC converters 220-1 to 220-n through the second PCS 320 (S216).

The plurality of DC-DC converters 120-1 to 120-n may convert discharged energy into a low voltage (e.g. 5V DC voltage) (S218), and supply the converted low voltage to the battery cells of the second group GROUP2 (S217).

According to embodiments, the remaining discharged energy supplied to the battery charging-discharging device among the discharged energy discharged from the plurality of batteries 350-1 to 350-m may be supplied to another load through the first PCS.

Referring back to FIG. 6, after the battery charging-discharging device charges 100% of the battery cells of the second group GROUP2, the battery charging-discharging device may perform full discharging (S220). When the battery charging-discharging device discharges the battery cells of the second group GROUP2, discharged energy may be stored in the energy storage device (S220). Since a method of storing the discharged energy of the charging-discharging device in the energy storage device is similar to the method described above with reference to FIG. 5, a detailed description thereof will be omitted.

The fully discharged battery cells of the second group may be shipped (S240), after a 30-60% of charging process is performed (S230).

As set forth above, according to the technical idea of the present disclosure, a battery charging-discharging system may increase a recovery rate of discharging energy and reuse the recovered discharging energy, thereby reducing energy consumption during charging and discharging of battery cells.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Therefore, the scope of the disclosure is defined not by the detailed description, but by the claims and their equivalents, and all variations within the scope of the claims and their equivalents are to be construed as being included in the disclosure.

What is claimed is:

1. A system for charging and discharging a battery, comprising:
a battery charging-discharging device performing a charging process and a discharging process of a plurality of battery cells for each group; and
an energy storage device, during a discharging process of battery cells of a first group, storing a discharged energy of the battery cells of the first group in a plurality of batteries, and, during a charging process of battery cells of a second group, supplying energy stored in the plurality of batteries to the battery cells of the second group.

2. The system for charging and discharging a battery of claim 1, wherein the energy storage device comprises,
a first power conversion system (PCS) for converting AC power into DC power, and supplying the converted DC power to the battery charging-discharging device,
wherein the battery charging-discharging device, comprises
a distribution board receiving the DC power from the first PCS; and
DC/DC converters connected to the distribution board in parallel,
wherein the distribution board distributes the DC power supplied from the first PCS to the battery cells of the first group through the DC-DC converters.

3. The system for charging and discharging a battery of claim 2, wherein the energy storage device, further comprises,
a power management system (PMS) for recognizing discharging of the battery cells of the first group through the first PCS during the discharging process, and outputting an energy storage command.

4. The system for charging and discharging a battery of claim 3, wherein the energy storage device, further comprises,
an energy management system (EMS), when the PMS monitors a status whether or not the first PCS is operating normally, and outputs the same, storing the status whether or not the first PCS is operating normally and displays the same.

5. The system for charging and discharging a battery of claim 3, wherein the energy storage device, further comprises,
a second power conversion system (PCS) storing discharged energy of the battery cells of the first group in the plurality of batteries, according to the energy storage command of the PMS.

6. The system for charging and discharging a battery of claim 5, wherein the energy storage device, further comprises,
a battery management system (BMS) for monitoring a status of the plurality of batteries, outputting status information according to the monitoring result, and controlling charging and discharging of the plurality of batteries,
wherein the PMS is configured to receive the status information from the BMS, and output the energy storage command to the second PCS, when the status of the plurality of batteries are in a chargeable state.

7. The system for charging and discharging a battery of claim 6, wherein the PMS is configured to receive the status information from the BMS, and output the energy discharging command to the second PCS, when the status of the plurality of batteries are in a dischargable state.

8. The system for charging and discharging a battery of claim 2, wherein the battery charging-discharging device, further comprises,
charging-discharging controllers for controlling the DC-DC converters; and
a manufacturing execution system (MES) for transmitting a charging initiation command for notifying a start of the charging process to the charging-discharging controllers.

9. The system for charging and discharging a battery of claim 2, wherein the battery charging-discharging device, further comprises,
a plurality of charging-discharging controllers connected to each of the DC/DC converters; and
a manufacturing execution systems (MES) for transmitting a charging-discharging initiation command for notifying a start of the charging process or the discharging process to the plurality of charging and discharging controllers,
wherein the plurality of charging-discharging controllers are configured to control an operation of the DC/DC converters in response to the charging-discharging initiation command.

10. The system for charging and discharging a battery of claim 9, wherein the energy storage device, further comprises,
a power management system (PMS) for outputting an energy storage command or an energy discharging command according to the status of the plurality of batteries; and
a second power conversion system (PCS), according to the energy storage command or energy discharge command of the PMS, storing discharged energy of the battery cells of the first group in the plurality of batteries, or supplying the energy stored in the plurality of batteries in the battery cells of the second group.
